(19) United States
(12) Patent Application Publication
(10) Pub. No.: US 2007/0008300 A1
(43) Pub. Date: Jan. 11, 2007

(54) Method and medium for variably arranging content menu and display device using the same

(75) Inventors: Gyung-hye Yang, Seoul (KR); Jung-hyun Shim, Seongnam-si (KR); Hyun-jeong Lee, Yongin-si (KR); Joon-ah Park, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/448,804

(22) Filed: Jun. 8, 2006

(30) Foreign Application Priority Data
Jul. 8, 2005 (KR) 10-2005-0061844

(51) Int. Cl. G09G 5/00

(52) U.S. Cl. 345/173

(57) ABSTRACT

A method and medium for variably arranging a content menu and a display device using the same are disclosed. The method for variably arranging a content menu includes a) detecting position information of a user's finger touched with a touch screen, b) setting an attention area in accordance with the detected position information, and c) arranging menu icons in accordance with the set attention area. The display device includes a position information detection unit for detecting position information of a user's finger touched with a touch screen, an area setting unit for setting an attention area in accordance with the position information detected by the position information detection unit, and a menu control unit for arranging menu icons in the attention area set by the area setting unit. Since the menu icons are arranged in the area near the user's finger by sensing the position of the user's finger touched with the touch screen, the menus can be manipulated efficiently and variably.

### CROSS-REFERENCE TO RELATED APPLICATIONS

This application claims priority from Korean Patent Application No. 10-2005-0061844 filed on Jul. 8, 2005 in the Korean Intellectual Property Office, the disclosure of which is incorporated herein by reference in its entirety.

### BACKGROUND OF THE INVENTION

1. Field of the Invention

The present invention relates to a method and medium for variably arranging content menu and a display device using the same, and more particularly, to a method and medium for variably arranging a content menu and a display device using the same, in which a touch sensor having a touch screen detects position information of a user's finger, who holds a front surface or both corners of the touch screen, and arranges menu icons near the user's finger to variably manipulate the content menu.

2. Description of the Related Art

Examples of prior art publications relating to a display device of a touch screen include US Patent Unexamined Publication No. 2004-0130576, Korean Patent Unexamined Publication No. 2004-0050541, and US Patent Unexamined Publication No. 2004-0100479.

The US Patent Unexamined Publication No. 2004-0130576 discloses a method for displaying a screen, in which an output image screen is combined with a manipulation image screen without overlap by a reduction or compression technique using a touch panel which does not shield a source image signal of a touch screen when a manipulation image screen including a manipulation button is displayed on the touch screen.

The US Patent Unexamined Publication No. 2004-0100479 discloses a display control method of an information terminal, in which a menu panel for displaying a menu item sets a predetermined moving track in a three-dimensional virtual space to obtain different kinds of transparency and a specific menu is three-dimensionally displayed in the panel if scrolling is manipulated.

The Korean Patent Unexamined Publication No. 2004-0050541 discloses a portable terminal whose display unit can be controlled in its size as shown in FIG. 1. Referring to FIG. 1, the portable terminal includes a display unit 11, a position sensor 13, a controller 14, and a slider 12. The slider 12 is slid along up and down directions of the display unit 11. In the portable terminal, the size of a display screen exposed by a user can be controlled by sliding control of the slider 12. Also, the size of message or image displayed on the exposed display screen is varied depending on variation in the size of the exposed display screen.

The aforementioned prior are publications are similar to one another in that they vary the size of the display unit depending on their use states. However, the prior art publications simply display the output image and the manipulation image displayed in the touch screen without overlap, three-dimensionally display a specific menu in a panel or vary the size of the screen or the size of the image depending on movement of the slider. The prior art publications do not variably arrange a menu icon depending on the position of a user's finger touched on the display screen.

Miniaturization of a portable device serves as an important factor because the portable device needs simple portability. In this respect, it is important to effectively arrange a small display window and a menu manipulator. However, since the display unit of the conventional portable device has a physically fixed manipulation area, it is difficult to vary the size of the menu manipulator and its arrangement position suitable for user's circumstances.

### SUMMARY OF THE INVENTION

Additional aspects, features and/or advantages of the invention will be set forth in part in the description which follows and, in part, will be apparent from the description, or may be learned by practice of the invention.

Accordingly, the present invention has been made to solve the above-mentioned problems occurring in the prior art. The present invention provides a method and medium for variably arranging a content menu and a display device using the same, in which a touch sensor detects position information of a user's finger, who holds a front surface or both corners of a touch screen, and arranges a menu icon near the user's finger to variably manipulate a menu manipulation area in accordance with the position of the user's finger.

Additional aspects, features, and advantages, of the present invention will be set forth in part in the description which follows and in part will become apparent to those having ordinary skill in the art upon examination of the following or may be learned from practice of the invention.

In one aspect of the present invention, there is provided a method and medium for variably arranging a content menu, according to the present invention, which includes a) detecting position information of a user's finger touched with a touch screen, b) setting an attention area in accordance with the detected position information, and c) arranging menu icons in accordance with the set attention area.

In another aspect of the present invention, there is provided a display device which includes a position information detection unit for detecting position information of a user's finger touched with a touch screen, an area setting unit for setting an attention area in accordance with the position information detected by the position information detection unit, and a menu control unit for arranging menu icons in the attention area set by the area setting unit.

In still another aspect of the present invention, there is provided a method and medium for variably arranging a content menu, which includes a) detecting position information of a user's finger touched with a corner of a touch screen, b).setting an attention area in accordance with the detected position information, and c) arranging menu icons in accordance with the set attention area.

In further still another aspect of the present invention, there is provided a display device which includes an information detector for detecting position information of a user's finger touched with a corner of a touch screen, an area setting unit for setting an attention area in accordance with the detected position information, and a menu control unit for arranging menu icons in accordance with the set attention area.

### BRIEF DESCRIPTION OF THE DRAWINGS

These and/or other aspects, features, and advantages of the invention will become apparent and more readily appreciated from the following description of the embodiments, taken in conjunction with the accompanying drawings of which:

FIG. 1 is a view illustrating a conventional portable terminal whose display part is controlled in its size;

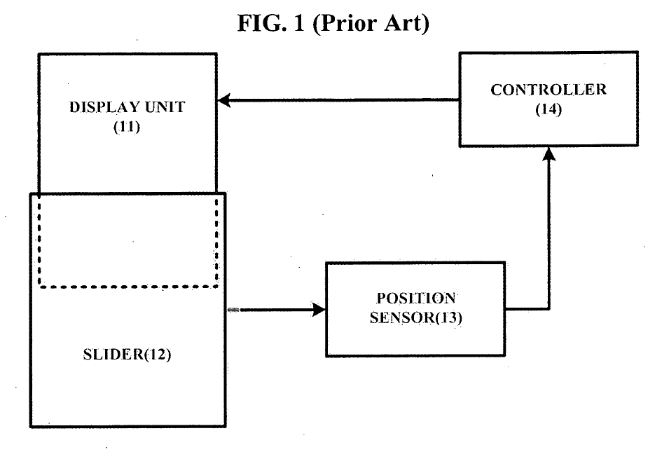

FIG. 2 is a view illustrating a display device using a method for variably arranging a content menu in accordance with one exemplary embodiment of the present invention;

FIG. 3 is a flowchart illustrating a method for variably arranging a content menu in accordance with one exemplary embodiment of the present invention;

FIG. 4 is a view illustrating a display device using a method for variably arranging a content menu in accordance with another exemplary embodiment of the present invention;

FIG. 5 is a flowchart illustrating a method for variably arranging a content menu in accordance with another exemplary embodiment of the present invention;

FIG. 6A is a view explaining a finger touch area and a menu arrangement area in a method for variably arranging a content menu in accordance with one exemplary embodiment of the present invention;

FIG. 6B is a view illustrating finger's angles in a method for variably arranging a content menu in accordance with another exemplary embodiment of the present invention;

FIGS. 7A to 7C are views explaining the principle that a display device using a method for variably arranging a content menu in accordance with an exemplary embodiment of the present invention senses finger's position information;

FIGS. 8 and 9 are view explaining a method for determining a start point and an end point of menu icon arrangement in a method for variably arranging a content menu in accordance with an exemplary embodiment of the present invention;

FIG. 10 is a view illustrating menu icon arrangements from a start point to an end point in a method for variably arranging a content menu in accordance with an exemplary embodiment of the present invention;

FIG. 11 is a view illustrating a menu arrangement area considering an attention area and an access area in a method for variably arranging a content menu in accordance with exemplary embodiment of the present invention;

FIGS. 12A to 12B is an exemplary view illustrating menu arrangements in an attention area in a method for variably arranging a content menu in accordance with an exemplary embodiment of the present invention;

FIG. 13 is an exemplary view illustrating the retrieval of an mp3 file in a method for variably arranging a content menu in accordance with an exemplary embodiment of the present invention;

FIG. 14 is an exemplary view illustrating a method for variably arranging a content menu on a front surface of a touch screen in accordance with an exemplary embodiment of the present invention;

FIG. 15 is a flowchart illustrating a method for variably arranging a content menu when a user grasps a corner of a touch screen in accordance with an exemplary embodiment of the present invention; and

FIG. 16 is an exemplary view illustrating a method for variably arranging a content menu when a user grasps a corner of a touch screen in accordance with an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

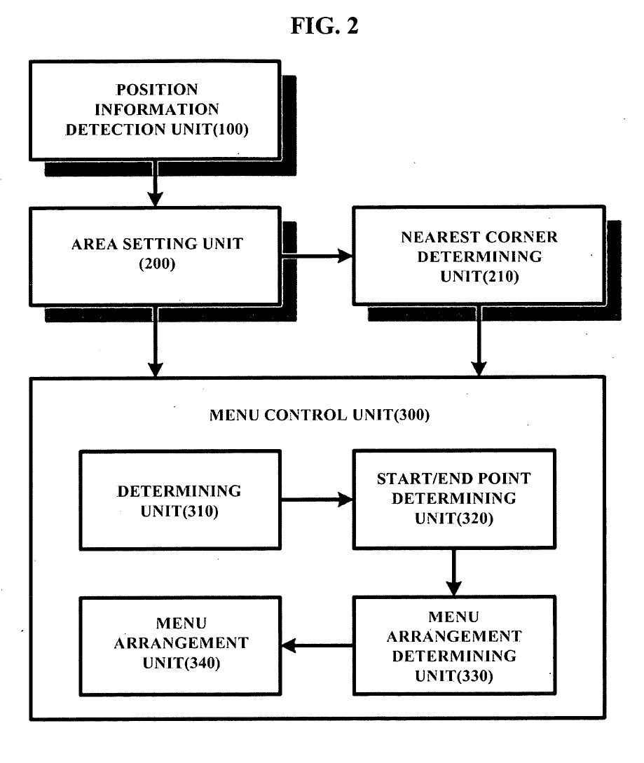

FIG. 2 illustrates a display device using a method for variably arranging a content menu in accordance with one exemplary embodiment of the present invention.

The display device using the method for variably arranging a content menu, as shown in FIG. 2, includes a position information detection unit 100, an area setting unit 200, a nearest corner determining unit 210, and a menu control unit 300. The menu control unit 300 includes a determining unit 310, a start/end point determining unit 320, a menu arrangement determining unit 330, and a menu arrangement unit 340.

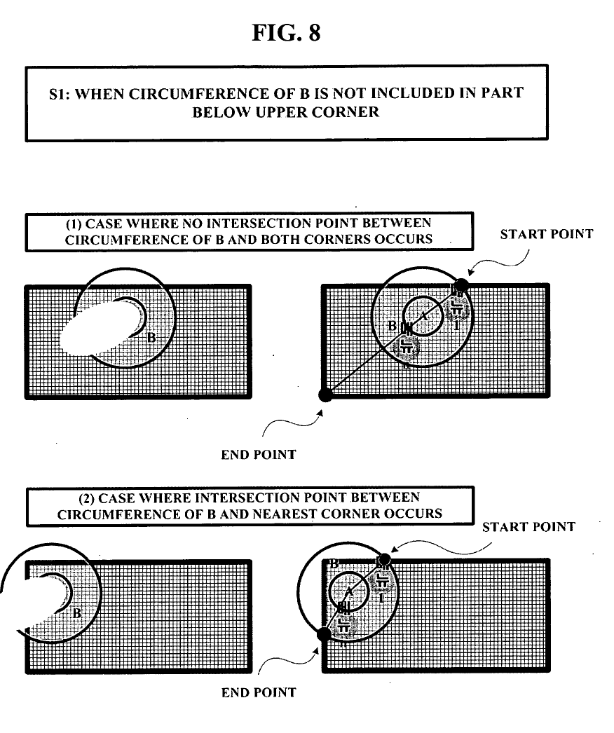

The position information detection unit 100 detects position information of a user's finger touched with a touch screen. This position information detection technique (method) is shown in FIGS. 7A to 7C.

FIG. 7A illustrates the principle that the display device senses position information of the user's finger in a pressure technique, FIG. 7B illustrates the principle that the display device senses position information of the user's finger in an infrared matrix technique, and FIG. 7C illustrates the principle that the display device senses position information of the user's finger in a scan technique.

In FIG. 7A, if the user's finger is touched with the touch screen, the position information detection unit 100 calculates a pressure point of a part touched with the touch screen as a coordinate value and detects the position information in accordance with the calculated coordinate value. In FIG. 7B, if the user's finger is touched with the touch screen, infrared rays are emitted from four corners of the touch screen and the emitted infrared rays are bumped again the user's finger to return to the original position. At this time, a part where the infrared rays does not pass through a matrix is calculated as an area, the position information detection unit 100 calculates a central point of an area corresponding to the user's finger touched with the touch screen as a coordinate value and detects the position information in accordance with the calculated coordinate value. Meanwhile, the sensing method of FIG. 7C based on the photo scan technique will be described later.

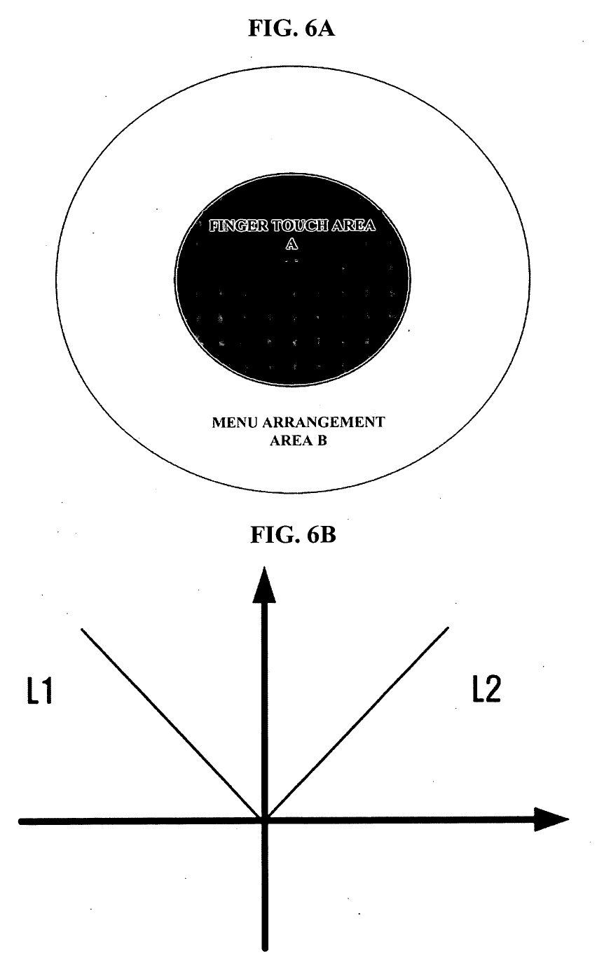

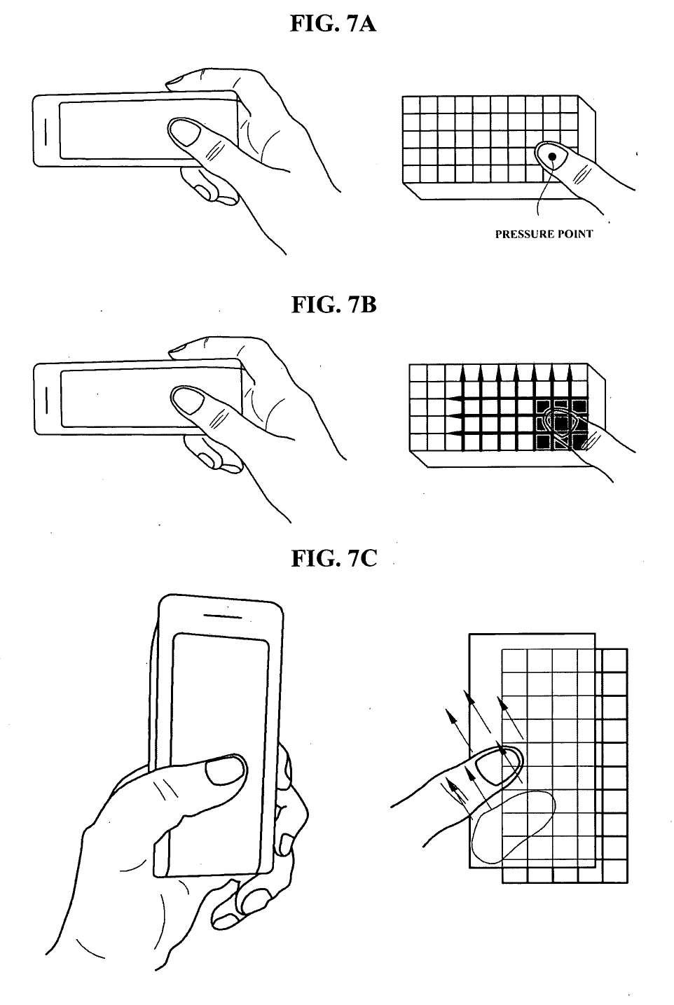

In an exemplary embodiment of the present invention, when the user's finger is touched with the touch screen, a sensor provided in the touch screen senses the user's finger and arranges menus near the touch screen as shown in FIG. 6A. FIG. 6A illustrates a finger touch area A and a menu arrangement area B when the user grasps the touch screen in the method for variably arranging a content menu.

The finger touch area A means an area that the user's finger is touched with the touch screen. The menu arrangement area B means an area that menu icons can be arranged around the user's finger. The finger touch area A to be displayed in the screen should be prescribed by a general standard because users' finger areas are too various to set a definite area. For example, the finger touch area A can be set within the range that a circle having a diameter of 0.5 cm to 1.5 cm or a circle such as a minimum circle having the width of the forefinger and a maximum circle having the width of the big finger is set using a coordinate value recognized by the user's finger touch as a central point. The menu arrangement area B can be set as an area obtained by subtracting the area A from a circle obtained by adding a diameter length of a menu icon to be arranged on the area B to a diameter length of the area A. At this time, since the diameter length of the menu icon is not absolutely required, the menu arrangement area B is optimized depending on the size of a display window and the number of menus.

Meanwhile, the area setting unit 200 serves to set an attention area depending on the position information detected by the position information detection unit 100.

The attention area means that the user unconsciously pays attention to the finger's periphery if its finger is touched with the touch screen. The attention area may be a peripheral area around the user's finger or a fan shaped area having a certain angle around the user's finger. The attention area is divided into first to n-th attention areas depending on the attention level. The first attention area is the highest attended area, and the second attention area is the second attended area. The attention area is generally called the n-th attention area. The attention area does not have the same concept as that of the menu arrangement area B of FIG. 6A. Since the first to n-th attention areas occur in the menu arrangement area B, the menu arrangement area B comes under a higher level than that of the attention areas.

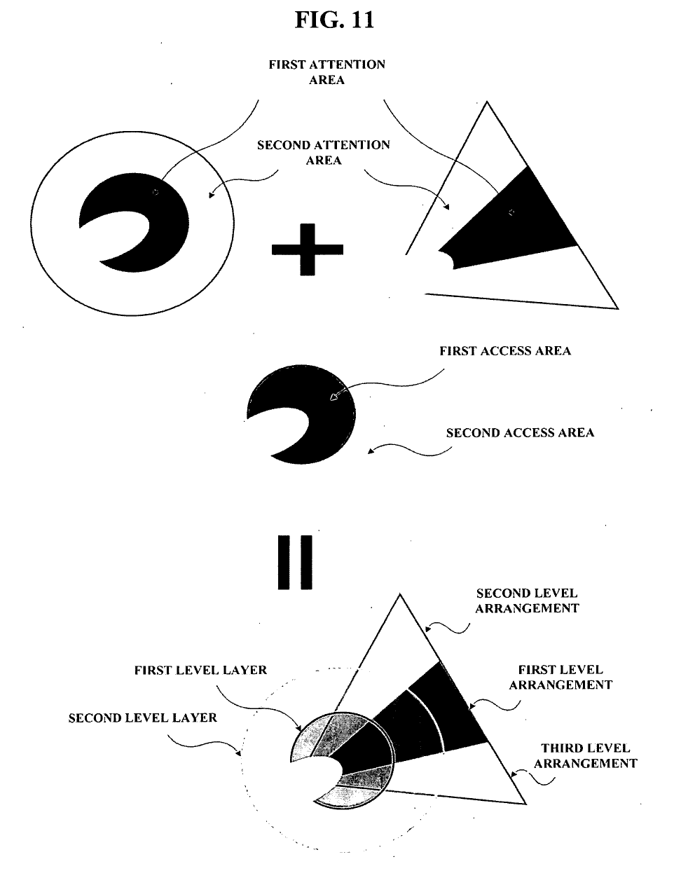

The area setting unit 200 sets an area within a certain distance from the user's finger touched with the touch screen as the first attention area, and also sets an area adjacent to the first attention area within a certain distance from the first attention area as the second attention area. In this way, the area setting unit 200 sets the first to n-th attention areas as shown in an upper side at the left of FIG. 11. The certain distance means a diameter length of a menu to be arranged in the touch screen or a length a little longer than the diameter length of the menu to include the menu. The user can optionally set the certain distance.

Furthermore, the area setting unit 200 sets an area within a certain angle from both directions around the user's finger touched with the touch screen as the first attention area, and also sets an area adjacent to the first attention area within a certain angle from both directions around the first attention area as the second attention area. In this way, the area setting unit 200 sets the first to n-th attention areas as shown in an upper side at the right of FIG. 11. The certain angle means a viewing angle that causes the user's attention at the highest level. Generally, the certain angle means an angle rotating in both directions from the user's finger when a circle is drawn around the touched point. The user can optionally set the certain angle.

The nearest corner determining unit 210 determines the nearest corner of the touch screen to determine a reference line for menu arrangement. The nearest corner means one of corners at both sides of the touch screen, which is the nearest one to the coordinate value showing the position of the user's finger. If the determined reference line for menu arrangement is the right corner of the touch screen, the nearest corner determining unit 210 serves to set it as L1. If the determined reference line for menu arrangement is the left corner of the touch screen, the nearest corner determining unit 210 serves to set it as L2. L1 and L2 are set to determine a menu arrangement direction for the sake of convenience. The menu arrangement direction will be described later.

The menu control unit 300 serves to arrange menu icons in the attention area set by the area setting unit 200. The menu control unit 300 includes four elements, which will be described below.

The determining unit 310 determines whether the circumference of the menu arrangement area where the menu icons are arranged is included in a part below the upper corner of the touch screen. Also, the determining unit 310 sets S1 if the circumference of the menu arrangement area is not included in the part below the upper corner of the touch screen. The determining unit 310 sets S2 if the circumference of the menu arrangement area is included in the part below the upper corner of the touch screen.

Meanwhile, the start/end point determining unit 320 determines a start point and an end point of the menu icon arrangement depending on the determined result of the determining unit 310.

In the case of S1, the start/end point determining unit 320 sets an intersection point between the upper corner of the touch screen and the circumference as the start point and an apex in a diagonal direction of the start point as the end point if an intersection point between the circumference and both corners of the touch screen does not occur.The start/end point determining unit 320 sets an intersection point between the upper corner of the touch screen and the circumference as the start point and an intersection point occurring in the nearest corner as the end point if an intersection point between the circumference and the nearest corner of both corners of the touch screen occurs.

Further, in the case of S2, the start/end point determining unit 320 sets an intersection point between the circumference and the nearest corner as a start point and an end point if the intersection point occurs and sets the intersection point occurring in the nearest corner as a start point and an intersection point occurring in the lower corner as an end point if the intersection points occur in both the nearest corner and the lower corner. The start/end point determining unit 320 sets an apex between the nearest corner of both corners of the touch screen and the upper corner as a start point and an apex between the nearest corner and the lower corner as an end point if no intersection point between the circumference and the corners of the touch screen occurs.

The menu arrangement determining unit 330 serves to determine arrangement of the menu icons from the start point to the end point, which are determined by the start/end point determining unit 330. The arrangement direction determined by the menu arrangement determining unit 330 is divided into two types, a counterclockwise direction in the case of L1 and a clockwise direction in the case of L2.

The menu arrangement unit 340 serves to arrange the menu icons in accordance with the arrangement direction determined by the menu arrangement determining unit 330. The menu arrangement unit 340 arranges the menu icons considering the first to n-th attention areas along with first to n-th access areas divided depending on the user's access easiness level.

Furthermore, the menu arrangement unit 340 may arrange menus in various lines. In this case, a higher menu icon is first arranged in a first access area. However, the higher menu icon is arranged again in a second access area at a lower menu icon. Therefore, the lower menu icon generated by selecting one menu of the higher menu icon is arranged in the first access area. The access area means a level showing how fast the user's finger or a digitizer pen accesses the menu icons.

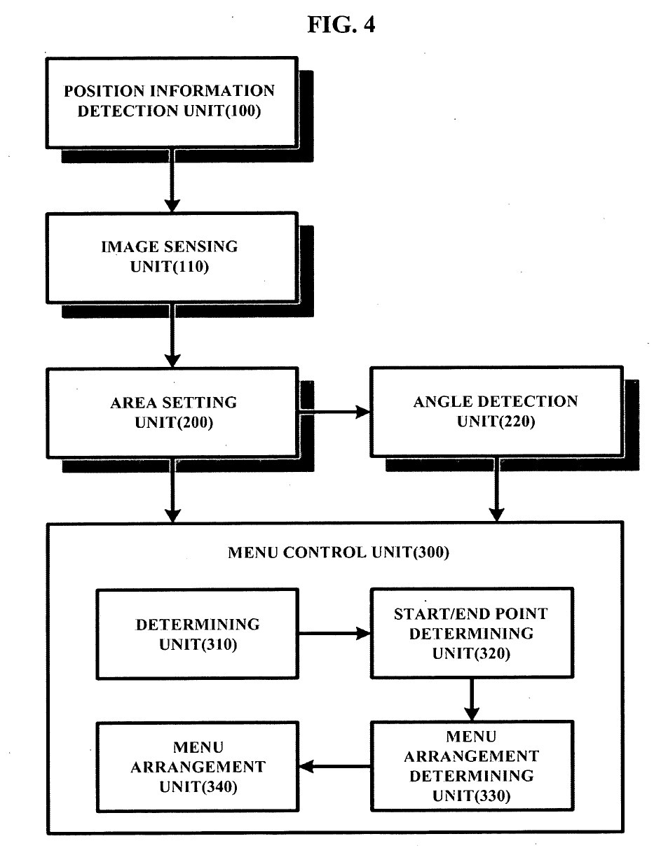

FIG. 4 is a view illustrating the construction of a display device using the method for variably arranging a content menu in accordance with the photo scan technique. Referring to FIG. 4, the position information detection unit 100, the area setting unit 200, and the menu control unit 300 perform the same functions as those of the display device using the method for variably arranging a content menu in accordance with the pressure technique and the infrared matrix technique of FIG. 2. Therefore, only an image sensing unit 110 and an angle detection unit 220 will be described.

Referring to FIG. 7C, if the user's finger is touched with the touch screen, the image sensing unit 110 scans the user's finger on the rear surface of the touch screen to sense an image of the user's finger. At this time, the position information detection unit 100 detects a shape of the user's finger and position information using the image sensed by the image sensing unit 110 to identify where the user's finger is currently positioned.

The angle detection unit 220 sets L1 if the user's finger detected by the scan result has a left orientation angle around a vertical axis of the touch screen while sets L2 if the user's finger has a right orientation angle. This is shown in FIG. 6B. FIG. 6B illustrates the step of determining L1 and L2 by setting the finger's angles in the method for variably arranging a content menu in accordance with the photo scan technique. In the same manner as the pressure and infrared matrix techniques, L1 and L2 are set to determine the menu arrangement direction for the sake of convenience.

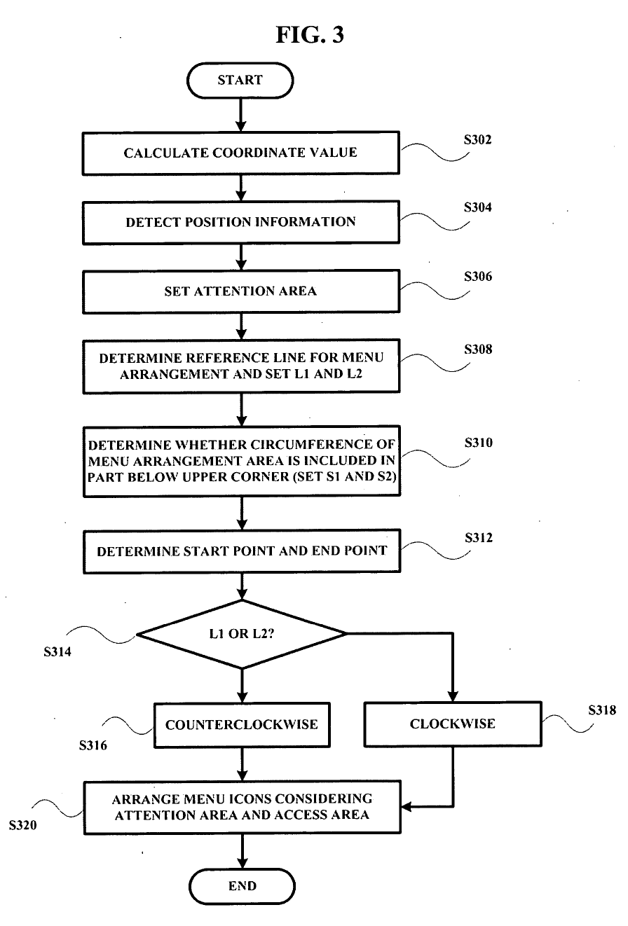

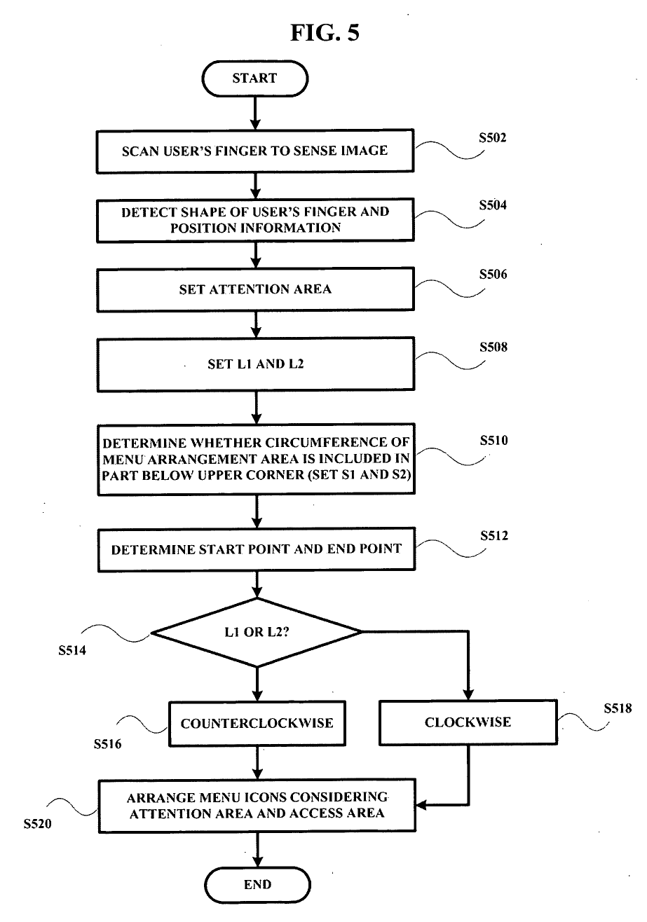

The method for variably arranging a content menu in accordance with the pressure and infrared matrix techniques will be described with reference to FIG. 3 while the method for variably arranging a content menu in accordance with the photo scan technique will be described with reference to FIG. 5. The method of FIG. 3 is different from the method of FIG. 5 in detecting the position information of the user's finger. Therefore, the other parts excluding this difference will be described equally.

First, the position information detection unit 100 should detect the position information of the user's finger touched with the touch screen. In the case of the pressure technique, the pressure point of the user's finger touched with the touch screen is calculated as the coordinate value S302, and the position information is detected in accordance with the calculated coordinate value S304. In the case of the infrared matrix technique, the area of the user's finger touched with the touch screen and a central point of this area are calculated as a coordinate value using infrared rays emitted from the peripheries of the touched part S302, and the position information is detected in accordance with the calculated coordinate value S304.

In the case of the photo scan technique, the image sensing unit 110 scans the user's finger touched with the touch screen on the rear surface of the touch screen to sense an image S502. And, the position information detection unit 100 detects the shape of the user's finger and position information using the image sensed by the image sensing unit 110 S504.

The next steps will be performed equally in the pressure technique, the infrared matrix technique, and the photo scan technique. Therefore, the next steps will be described together with reference to FIGS. 3 and 5.

The area setting unit 200 sets the attention area in accordance with the position information detected by the position information detection unit 100 S306.

As mentioned above, the attention area means an area showing the user's attention level to the touch screen around the user's finger. The attention area may be divided into various areas in accordance with the attention level. In an exemplary embodiment of the present invention, the attention area is divided into various areas in accordance with two examples of the attention level.

In one example, an area within a certain distance plus the diameter length of the menu to be arranged in the touch screen based on the pressure point of the user's finger touched with the touch screen is set as a first attention area, and an area adjacent to the first attention area within a concentric circle plus the diameter length from the first attention area is set as a second attention area. In this way, the first to n-th attention areas can be set.

In the other example, a fan shaped area within a certain angle of both directions around the user's finger touched with the touch screen is set as a first attention area, and a new area adjacent to the first attention area within a certain angle of both directions from the first attention area is set as a second attention area. In this way, the first to n-th attention areas can be set.

In the case of the pressure and infrared matrix techniques, the nearest corner determining unit 210 determines the nearest corner to the position of the coordinate value among both corners of the touch screen. Also, the nearest corner determining unit 210 determines the nearest corner as a reference line for menu arrangement, and sets L1 if the determined reference line for menu arrangement is a right corner of the touch screen while sets L2 if the determined reference line for menu arrangement is a left corner of the touch screen S308.

In the case of the photo scan technique, the angle detection unit 220 sets L1 if the user's finger detected by the scan result has a left orientation angle around the vertical axis of the touch screen while sets L2 if the user's finger has a right orientation angle S508.

The menu control unit 300 arranges menu icons in accordance with the attention area set by the area setting unit 200. This will be described below.

The determining unit 310 determines whether the circumference of the menu arrangement area where the menu icons are arranged is included in a part below the upper corner of the touch screen. Thus, the determining unit 310 sets S1 if the circumference of the menu arrangement area is not included in the part below the upper corner of the touch screen while the determining unit 310 sets S2 if the circumference of the menu arrangement area is included in the part below the upper corners of the touch screen S310 and S510. S1 and S2 are set for the sake of convenience.

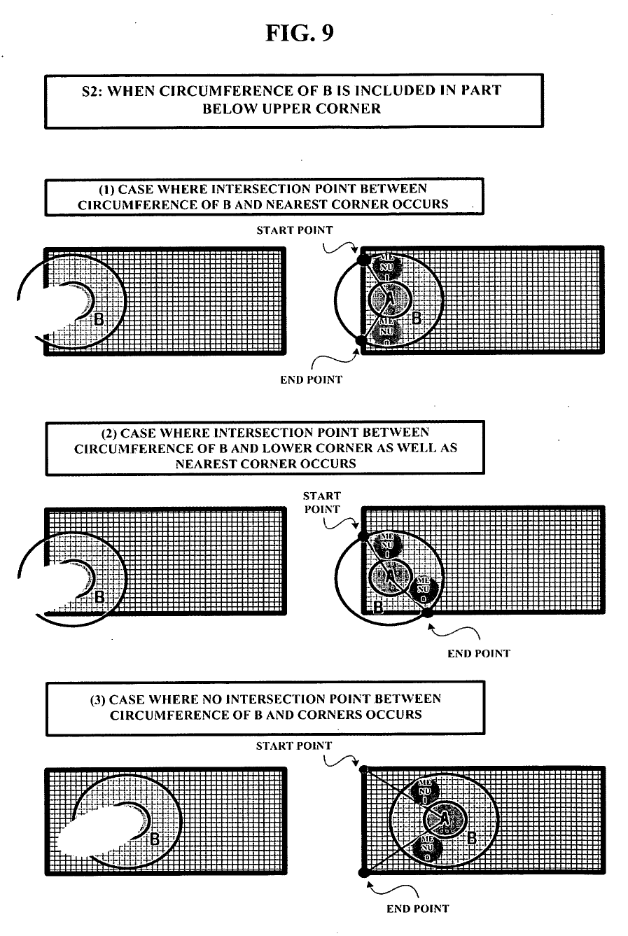

The start/end point determining unit 320 determines the start point and the end point of the menu icon arrangement depending on the determined result of the determining unit 310 S312 and S512. This is shown in FIGS. 8 and 9.

FIGS. 8 and 9 illustrate a technique for determining the start point and the end point of menu icon arrangement in the method for variably arranging a content menu in accordance with an exemplary embodiment of the present invention.

In the case of S1, the circumference of the menu arrangement area B is not included in the part below the upper corner of the touch screen as shown in FIG. 8. In this case, there are provided two cases. If the intersection point between the circumference and both corners of the touch screen does not occur ((1) of FIG. 8), the intersection point between the upper corner of the touch screen and the circumference is set as the start point and the apex in a diagonal direction of the start point is set as the end point. If the intersection point between the circumference and the nearest corner of both corners of the touch screen occurs ((2) of FIG. 8), the intersection point between the upper corner of the touch screen and the circumference is set as the start point and the intersection point occurring in-the nearest corner is set as the end point.

In the case of S2, the circumference of the menu arrangement area B is included in the part below the upper corner of the touch screen as shown in FIG. 9. In this case, there are provided three cases. First, if the intersection point between the circumference and the nearest corner only occurs ((1) of FIG. 9), the intersection point is set as the start point and the end point. Second, if the intersection points between the circumference and the nearest corner and between the circumference and the lower corner occur ((2) of FIG. 9), the one is set as the start point while the other one is set as the end point. Finally, if no intersection point between the circumference and the corners of the touch screen occurs ((3) of FIG. 9), the apex between the nearest corner and the upper corner is set as the start point and the apex between the nearest corner and the lower corner is set as the end point.

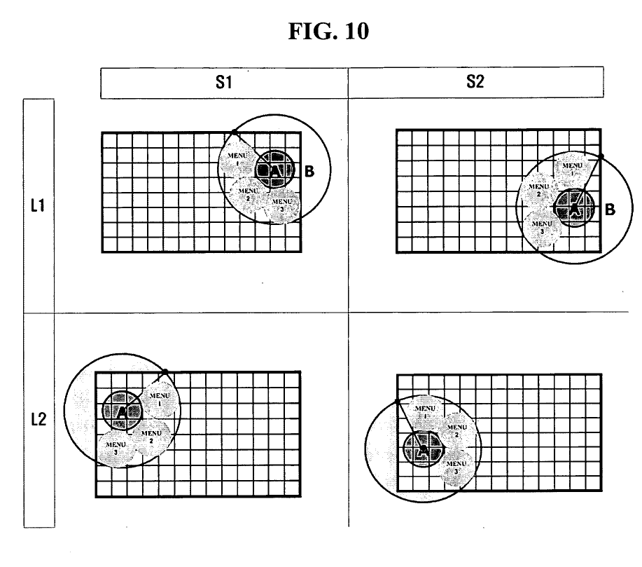

Next, the menu arrangement determining unit 330 determines arrangement of the menu icons from the start point to the end point. In this case, the menu arrangement determining unit 330 is required to determine whether the menu icons come under L1 or L2 S314 and S514. In the case of L1, the menu icons are arranged counterclockwise S316 and S516. In the case of L2, the menu icons are arranged clockwise S318 and S518. This is shown in FIG. 10. FIG. 10 illustrates menu icon arrangements from the start point to the end point in the method for variably arranging a content menu in accordance with an exemplary embodiment of the present invention. As shown in FIG. 10, in the case of L1, the start point of menu arrangement is different from the end point of menu arrangement but the menu icons are arranged counterclockwise in either case of S1 and S2. In the case of L2, the start point of menu arrangement is different from the end point of menu arrangement but the menu icons are arranged clockwise in either case of S1 and S2. The reason why menu arrangement is divided into L1 and L2 is to obtain the menu arrangement area because the menu arrangement area excluding the touch part of the user's finger is varied depending on which part of the touch screen is grasped by the user's finger.

The menu arrangement unit 340 arranges the menu icons in accordance with the determined arrangement. In this case, the menu icons should be arranged considering the attention area and the access area S320 and S520. FIG. 11 illustrates the menu arrangement area divided considering the attention area and the access area in the method for variably arranging a content menu in accordance with an exemplary embodiment of the present invention. The attention area may be divided into areas of a concentric circle based on the user's finger touched with the touch screen. Alternatively, the attention area may be divided into areas in accordance with angles. For example, first to n-th attention areas divided as shown in FIG. 11 are overlapped with first to n-th access areas divided depending on the user's access easiness, and the inside of the first access area is again divided into areas in accordance with the order of the attention area and the menu icons are respectively arranged in the divided areas. In other words, the small circle around the user's finger is set as a first level layer of the first access area as shown in a lower side of FIG. 11, and a ring area excluding the small circle is set as a second level layer of the second access area. In this way, the menu icons are arranged from the first level layer to the n-th level layer.

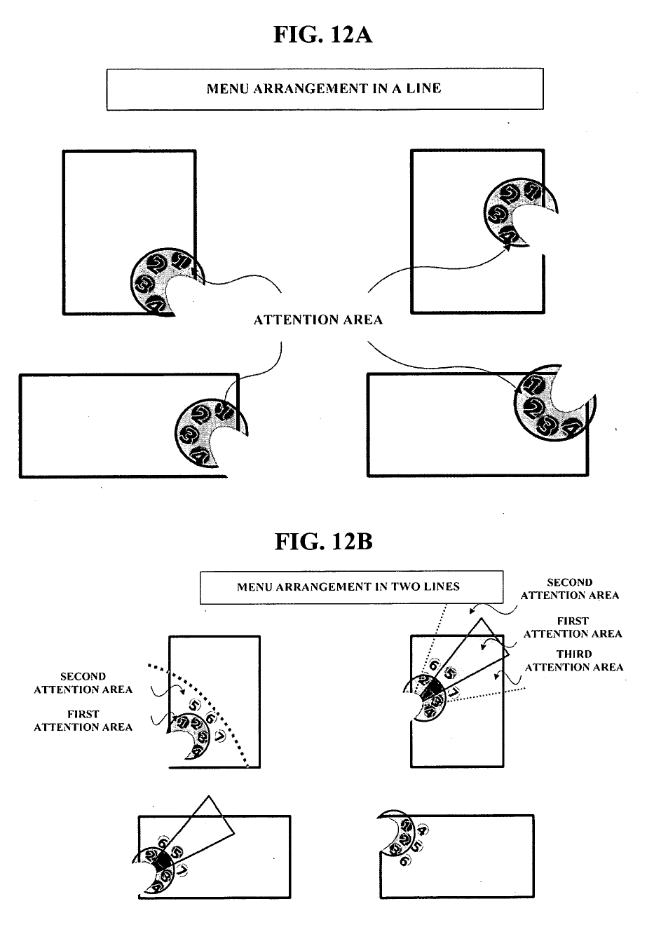

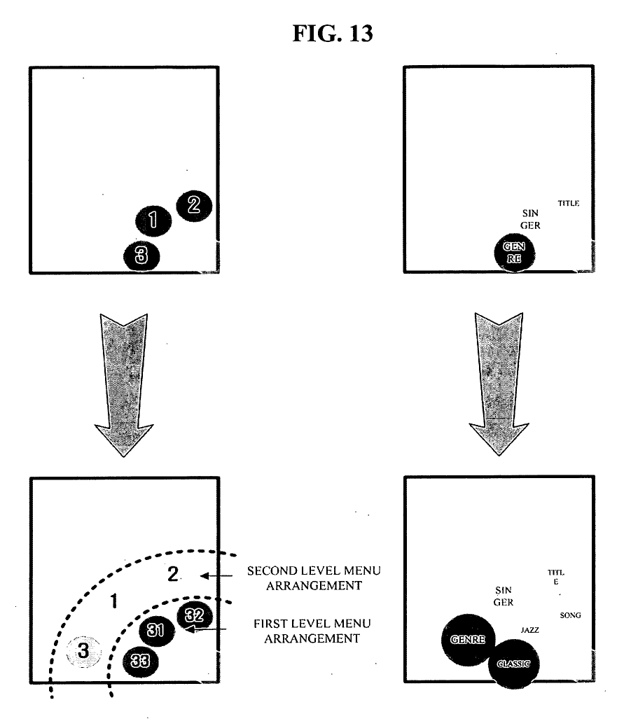

FIGS. 12A and 12B exemplarily illustrate menu arrangements in the attention area in the method for variably arranging a content menu in accordance with an exemplary embodiment of the present invention, and FIG. 13 exemplarily illustrates retrieval of mp3 file using the method for variably arranging a content menu in accordance with an exemplary embodiment of the present invention.

FIG. 12A illustrates a menu arrangement in the attention area in one line, and FIG. 12B illustrates menu arrangement in two lines.

Particularly, referring to FIG. 12B, the menu icons are not always arranged clockwise or counterclockwise. The attention area may be arranged in a fan shape of a certain angle as shown in an upper side at the right of FIG. 12B.

Referring to FIG. 13, a higher menu is first divided into title, singer, and genre in one line. If the user selects genre, the higher menu corresponding to title, singer, and genre is upward pushed toward the second access area, and the selected genre menu is a little enlarged and activated. Menus lower than the selected genre menu are comprised of song, jazz, and classic. These lower menus are arranged as the first level menu in the first access area. In other words, if the user selects one of menus in the first access area and thus the lower menu is arranged, the original higher menu icon is arranged in the second access area and the lower menu icon is forward arranged in the first access area. At this time, the menu icons are arranged in the second access area in accordance with the order of the attention area.

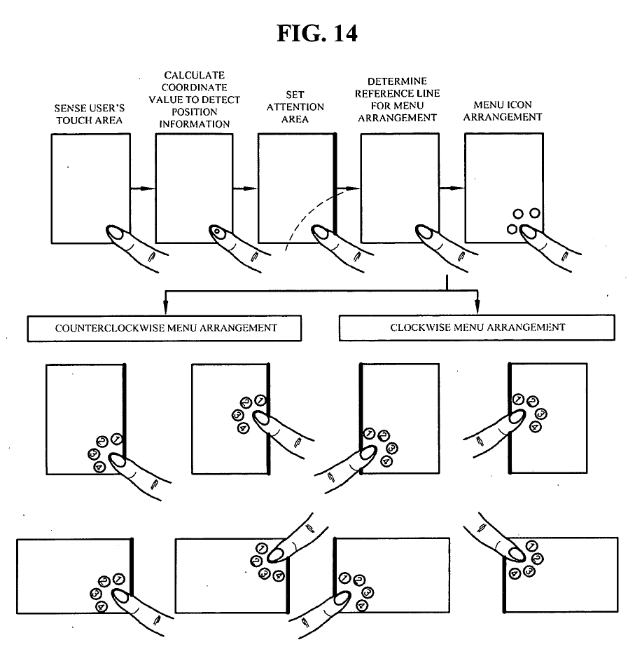

The aforementioned menu arrangement is shown in FIG. 14. FIG. 14 exemplarily illustrates the method for variably arranging a content menu on the front surface of the touch screen depending on counterclockwise menu arrangement and clockwise menu arrangement as mentioned above.

It is apparent that the present invention may be embodied in a computer programmable recording medium that can record the aforementioned exemplary embodiments of methods for variably arranging a content menu using a computer.

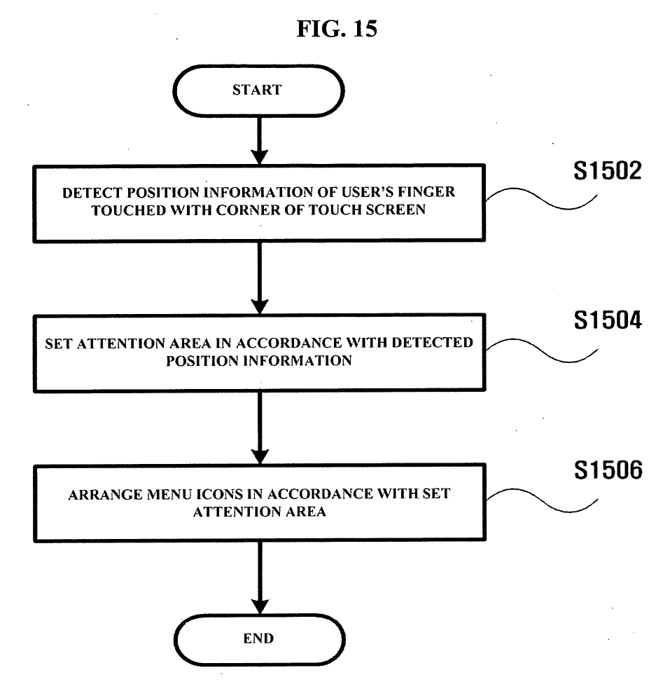

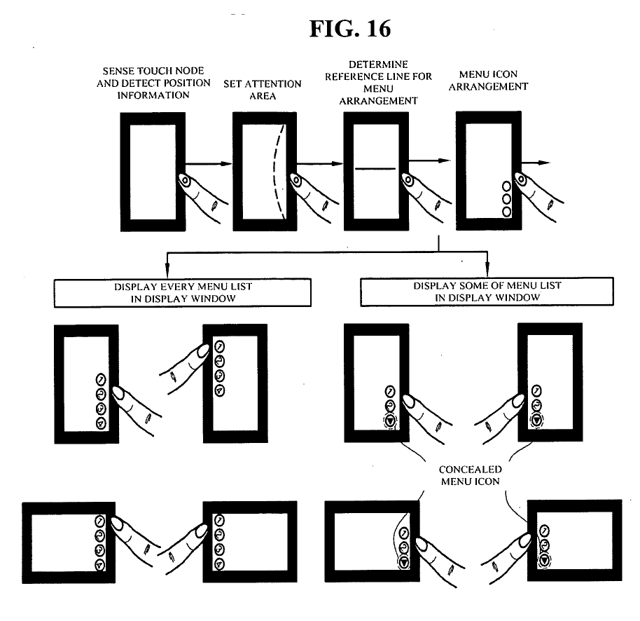

Meanwhile, exemplary embodiments of methods of the present invention may be realized in the case where the user's finger is touched with the front surface of the touch screen. Also, exemplary embodiments of methods of the present invention may be realized in the case where the user's finger is touched with the corner part of the touch screen as shown in FIG. 15 and FIG. 16.

FIG. 15 is a flowchart illustrating the method for variably arranging a content menu when the user grasps the corner of the touch screen in accordance with an exemplary embodiment of the present invention.

If the position information detection unit 100 detects position information of the user's finger touched with the corner of the touch screen S1502, the area setting unit 200 sets the attention area in accordance with the position information detected by the position information detection unit 100 S1504.

In this case, the attention area is set differently from the aforementioned menu arrangement on the front surface of the touch screen. In other words, the first attention area is set to arrange the menu icons in a line along the corner of the touch screen touched with the user's finger, and an area adjacent to the first attention area within an area plus the diameter length of the menu to be arranged in the touch screen based on the first attention area is set as the second attention area. In this way, the first to n-th attention areas are set.

The menu control unit 300 arranges the menu icons in accordance with the attention are set by the area setting unit 200 S1506. At this time, the menu icons are arranged in a line along the attention area, and a menu concealment icon is additionally arranged if the n-th attention area does not have any sufficient space where the menu icons are to be arranged in a line. This is shown in FIG. 16. FIG. 16 exemplarily illustrates the method for variably arranging a content menu when the user grasps the corner of the touch screen in accordance with an exemplary embodiment of the present invention. Referring to FIG. 16, the attention area is set in a line along the corner from the area near the user finger touched with the corner of the touch screen so that the menus are arranged. At this time, the menu list is displayed in the display window as shown in a left side of FIG. 16. If the menu list is not fully displayed in the display window, a menu concealment icon can be used as shown in a right side of FIG. 16. If the user's finger is touched with the part near the apex in the corner area of the touch screen, the space to be arranged in a line is insufficient. For this reason, the menu concealment icon is used. As a result, it is possible to efficiently use the display area.

It is apparent that exemplary embodiments of the present invention may be embodied in a computer programmable recording medium that can record exemplary embodiments of methods for arranging a content menu by detecting position information of the user's finger touched with the corner of the touch screen.

As described above, in exemplary embodiments of methods for variably arranging a content menu and the display device using the same according to the present invention, since the menu icons are arranged in the area near the user's finger by sensing the position of the user's finger touched with the touch screen, the manipulation position of the menu is not limited and the menu can efficiently be manipulated. Also, since there is no area covered by the user's finger, it is possible to variably manipulate the menu.

Moreover, the menus are arranged in the priority order of the menu manipulation considering the user's attention level and the access level, and efficient retrieval of information can be made.

In addition to the above-described exemplary embodiments, exemplary embodiments of the present invention can also be implemented by executing computer readable code/instructions in/on a medium, e.g., a computer readable medium. The medium can correspond to any medium/media permitting the storing and/or transmission of the computer readable code.

The computer readable code/instructions can be recorded/transferred in/on a medium in a variety of ways, with examples of the medium including magnetic storage media (e.g., floppy disks, hard disks, magnetic tapes, etc.), optical recording media (e.g., CD-ROMs, or DVDs), magneto-optical media (e.g., floptical disks), hardware storage devices (e.g., read only memory media, random access memory media, flash memories, etc.) and storage/transmission media such as carrier waves transmitting signals, which may include instructions, data structures, etc. Examples of storage/transmission media may include wired and/or wireless transmission (such as transmission through the Internet). Examples of wired storage/transmission media may include optical wires and metallic wires. The medium/media may also be a distributed network, so that the computer readable code/instructions is stored/transferred and executed in a distributed fashion. The computer readable code/instructions may be executed by one or more processors.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A method for variably arranging a content menu, comprising:
a) detecting position information of a user's finger touched with a touch screen;
b) setting an attention area in accordance with the detected position information; and
c) arranging menu icons in accordance with the set attention area.

2. The method as claimed in claim 1, wherein the step a) comprises:
calculating a pressure point of a part touched with the touch screen as a coordinate value; and
detecting the position information of the user's finger in accordance with the calculated coordinate value.

3. The method as claimed in claim 1, wherein the step a) comprises:
calculating an area of a part touched with the touch screen using infrared rays emitted from the periphery of the part touched with the touch screen;
calculating a central point of the calculated area as a coordinate value; and
detecting the position information of the user's finger in accordance with the calculated coordinate value.

4. The method as claimed in claim 1, wherein the step a) comprises:
scanning the user's finger touched with the touch screen on a rear surface of the touch screen to sense an image; and
detecting a shape of the user's finger and position information using the sensed image.

5. The method as claimed in claim 1, wherein the step b) comprises setting first to n-th attention areas by setting an area within a certain distance plus a diameter length of a menu to be arranged in the touch screen based on the position of the user's finger touched with the touch screen as the first attention area, and setting an area adjacent to the first attention area within a certain distance plus the diameter length based on the first attention area as the second attention area.

6. The method as claimed in claim 1, wherein the step b) comprises setting first to n-th attention areas by setting an area within a certain angle of both directions based on a direction of the user's finger touched with the touch screen as the first attention area, and setting an area adjacent to the first attention area within a certain angle of both directions based on the first attention area as the second attention area.

7. The method as claimed in claim 2, further comprising before the step c):
determining a corner nearest to the position of the coordinate value among both corners of the touch screen as a reference line for menu arrangement; and
setting L1 if the determined reference line for menu arrangement is a right corner of the touch screen, and setting L2 if the determined reference line is a left corner.

8. The method as claimed in claim 3, further comprising before the step c):
determining a corner nearest to the position of the coordinate value among both corners of the touch screen as a reference line for menu arrangement; and
setting L1 if the determined reference line for menu arrangement is a right corner of the touch screen, and setting L2 if the determined reference line is a left corner.

9. The method as claimed in claim 4, further comprising before the step c):
setting L1 if the user's finger detected by the scan result has a left orientation angle based on a vertical axis of the touch screen, and setting L2 if the user's finger has a right orientation angle.

10. The method as claimed in claim 7, wherein the step c) comprises:
c1) determining whether the circumference of a menu arrangement area where the menu icons are arranged is included in a part below an upper corner of the touch screen;
c2) determining a start point and an end point of menu icon arrangement in accordance with the determined result;
c3) determining an arrangement direction of the menu icons from the start point to the end point; and
c4) arranging the menu icons in accordance with the determined arrangement direction.

11. The method as claimed in claim 10, wherein the step c1) comprises setting S1 if the circumference of the menu arrangement area is not included in the part below the upper corner of the touch screen and setting S2 if the circumference of the menu arrangement area is included in the part below the upper corner of the touch screen.

12. The method as claimed in claim 11, wherein the step c2) comprises in the case of S1:
setting an intersection point between the upper corner of the touch screen and the circumference as a start point and an apex in a diagonal direction of the start point as an end point if an intersection point between the circumference and both corners of the touch screen does not occur; and
setting the intersection point between the upper corner of the touch screen and the circumference as a start point and an intersection point occurring in the nearest corner as an end point if the intersection point between the circumference and the nearest corner of both corners of the touch screen occurs.

13. The method as claimed in claim 11, wherein the step c2) comprises in the case of S2:
setting an intersection point between the circumference and the nearest corner as a start point and an end point if the intersection point between the circumference and the nearest corner occurs;
setting an intersection point between the circumference and the nearest corner as a start point and an intersection point between the circumference and a lower corner as an end start point if the intersection point between the circumference and the lower corner as well as the nearest corner occurs; and
setting an apex between the nearest corner of both corners of the touch screen and the upper corner as a start point and an apex between the nearest corner and the lower corner as an end point if no intersection point between the circumference and the corners of the touch screen occurs.

14. The method as claimed in claim 10, wherein the arrangement direction in the step c3) is counterclockwise in the case of L1 and clockwise in the case of L2.

15. The method as claimed in claim 10, wherein the step c4) comprises arranging the menu icons considering the attention area along with first to n-th access areas divided depending on the user's access easiness.

16. The method as claimed in claim 15, wherein the first access area is provided with a first higher menu icon, the first higher menu icon is moved to the second access area if a menu icon lower than the first higher menu icon is generated, and the lower menu icon is arranged in the first access area.

17. A computer-readable medium comprising computer readable instructions for executing the method of claim 1.

18. A display device comprising:
a position information detection unit detecting position information of a user's finger touched with a touch screen;
an area setting unit setting an attention area in accordance with the position information detected by the position information detection unit; and
a menu control unit arranging menu icons in the attention area set by the area setting unit.

19. The display device as claimed in claim 18, wherein the position information detection unit calculates a pressure point of a part touched with the touch screen as a coordinate value, and detects the position information of the user's finger in accordance with the calculated coordinate value.

20. The display device as claimed in claim 18, wherein the position information detection unit calculates a central point of an area of a user's finger part touched with the touch screen as a coordinate value using infrared rays emitted from the periphery of the part touched with the touch screen, and detects the position information in accordance with the calculated coordinate value.

21. The display device as claimed in claim 18, further comprising an image sensing unit for scanning the user's finger touched with the touch screen on a rear surface of the touch screen to sense an image;
wherein the image sensing unit detects a shape of the user's finger and position information using the image sensed by the image sensing unit.

22. The display device as claimed in claim 18, wherein the area setting unit sets first to n-th attention areas by setting an area within a certain distance plus a diameter length of a menu to be arranged in the touch screen based on the position of the user's finger touched with the touch screen as the first attention area and setting an area adjacent to the first attention area within a certain distance plus the diameter length based on the first attention area as the second attention area.

23. The display device as claimed in claim 18, wherein the area setting unit sets first to n-th attention areas by setting an area within a certain angle of both directions based on a direction of the user's finger touched with the touch screen as the first attention area, and setting an area adjacent to the first attention area within a certain angle of both directions based on the first attention area as the second attention area.

24. The display device as claimed in claim 19, further comprising a nearest corner determining unit that determines a corner nearest to the position of the coordinate value among both corners of the touch screen as a reference line for menu arrangement, sets L1 if the determined reference line for menu arrangement is a right corner of the touch screen, and sets L2 if the determined reference line is a left corner.

25. The display device as claimed in claim 20, further comprising a nearest corner determining unit that determines a corner nearest to the position of the coordinate value among both corners of the touch screen as a reference line for menu arrangement, sets L1 if the determined reference line for menu arrangement is a right corner of the touch screen, and sets L2 if the determined reference line is a left corner.

26. The display device as claimed in claim 21, further comprising a nearest corner determining unit that sets L1 if the user's finger detected by the scan result has a left orientation angle based on a vertical axis of the touch screen, and sets L2 if the user's finger has a right orientation angle.

27. The display device as claimed in claim 24, wherein the menu control unit comprises:
a determining unit for determining whether the circumference of a menu arrangement area where the menu icons are arranged is included in a part below an upper corner of the touch screen;
a start/end point determining unit for determining a start point and an end point of menu icon arrangement in accordance with the determined result of the determining unit;
a menu arrangement determining unit for determining an arrangement direction of the menu icons from the start point to the end point determined by the start/end point determining unit; and
a menu arrangement unit arranging the menu icons in accordance with the arrangement direction determined by the menu arrangement determining unit.

28. The display device as claimed in claim 27, wherein the determining unit sets S1 if the circumference of the menu arrangement area is not included in the part below the upper corner of the touch screen, and sets S2 if the circumference of the menu arrangement area is included in the part below the upper corner of the touch screen.

29. The display device as claimed in claim 28, wherein the start/end point determining unit, in the case of S1, sets an intersection point between the upper corner of the touch screen and the circumference as a start point and an apex in a diagonal direction of the start point as an end point if an intersection point between the circumference and both corners of the touch screen does not occur, and sets an intersection point between the upper corner of the touch screen and the circumference as a start point and an intersection point occurring in the nearest corner as an end point if the intersection point between the circumference and the nearest corner of both corners of the touch screen occurs.

30. The display device as claimed in claim 28, wherein the start/end point determining unit, in the case of S2, sets an intersection point between the circumference and the nearest corner as a start point and an end point if the intersection point between the circumference and the nearest corner occurs, sets an intersection point between the circumference and the nearest corner as a start point and an intersection point between the circumference and a lower corner as an end start point if the intersection point between the circumference and the lower corner as well as the nearest corner occurs, and sets an apex between the nearest corner of both corners of the touch screen and the upper corner as a start point and an apex between the nearest corner and the lower corner as an end point if no intersection point between the circumference and the corners of the touch screen occurs.

31. The display device as claimed in claim 27, wherein the arrangement direction of the menu arrangement determining unit is counterclockwise in the case of L1, and clockwise in the case of L2.

32. The display device as claimed in claim 27, wherein the menu arrangement unit arranges the menu icons considering the attention area along with first to n-th access areas divided depending on the user's access easiness.

33. The display device as claimed in claim 32, wherein the menu arrangement unit includes a first higher menu icon arranged in the first access area, the first higher menu icon being moved to the second access area if a menu icon lower than the first higher menu icon is generated, and the lower menu icon being arranged in the first access area.

34. A method for variably arranging a content menu, comprising:
a) detecting position information of a user's finger touched with a corner of a touch screen;
b) setting an attention area in accordance with the detected position information; and
c) arranging menu icons in accordance with the set attention area.

35. The method as claimed in claim 34, wherein the step b) comprises setting first to n-th attention areas by setting the first attention area to arrange the menu icons in a line along the corner of the touch screen touched with the user's finger, and setting the second attention area adjacent to the first attention area within an area plus a diameter length of a menu to be arranged in the touch screen based on the first attention area.

36. The method as claimed in claim 35, wherein the step c) comprises arranging the menu icons in a line along the attention area, and additionally arranging a menu concealment icon if the n-th attention area does not have any sufficient space where the menu icons are to be arranged in a line.

37. A computer-readable medium comprising computer readable instructions for executing the method of claim 34.

38. A display device comprising:
a position information detection unit detecting position information of a user's finger touched with a corner of a touch screen;
an area setting unit setting an attention area in accordance with the detected position information; and
a menu control unit arranging menu icons in accordance with the set attention area.

39. The display device as claimed in claim 38, wherein the area setting unit sets first to n-th attention areas by setting the first attention area to arrange the menu icons in a line along the corner of the touch screen touched with the user's finger, and setting the second attention area adjacent to the first attention area within an area plus a diameter length of a menu to be arranged in the touch screen based on the first attention area.

40. The display device as claimed in claim 39, wherein the menu control unit arranges the menu icons in a line along the attention area, and additionally arranges a menu concealment icon if the n-th attention area does not have any sufficient space where the menu icons are to be arranged in a line.

41. The method as claimed in claim 8, wherein the step c) comprises:
c1) determining whether the circumference of a menu arrangement area where the menu icons are arranged is included in a part below an upper corner of the touch screen;
c2) determining a start point and an end point of menu icon arrangement in accordance with the determined result;
c3) determining an arrangement direction of the menu icons from the start point to the end point; and
c4) arranging the menu icons in accordance with the determined arrangement direction.

42. The method as claimed in claim 41, wherein the step c1) comprises setting S1 if the circumference of the menu arrangement area is not included in the part below the upper corner of the touch screen and setting S2 if the circumference of the menu arrangement area is included in the part below the upper corner of the touch screen.

43. The method as claimed in claim 42, wherein the step c2) comprises in the case of S1:
setting an intersection point between the upper corner of the touch screen and the circumference as a start point and an apex in a diagonal direction of the start point as an end point-if an intersection point between the circumference and both corners of the touch screen does not occur; and
setting the intersection point between the upper corner of the touch screen and the circumference as a start point and an intersection point occurring in the nearest corner as an end point if the intersection point between the circumference and the nearest corner of both corners of the touch screen occurs.

44. The method as claimed in claim 42, wherein the step c2) comprises in the case of S2:
setting an intersection point between the circumference and the nearest corner as a start point and an end point if the intersection point between the circumference and the nearest corner occurs;
setting an intersection point between the circumference and the nearest corner as a start point and an intersection point between the circumference and a lower corner as an end start point if the intersection point between the circumference and the lower corner as well as the nearest corner occurs; and
setting an apex between the nearest corner of both corners of the touch screen and the upper corner as a start point and an apex between the nearest corner and the lower corner as an end point if no intersection point between the circumference and the corners of the touch screen occurs.

45. The method as claimed in claim 41, wherein the arrangement direction in the step c3) is counterclockwise in the case of L1 and clockwise in the case of L2.

46. The method as claimed in claim 41, wherein the step c4) comprises arranging the menu icons considering the attention area along with first to n-th access areas divided depending on the user's access easiness.

47. The method as claimed in claim 46, wherein the first access area is provided with a first higher menu icon, the first higher menu icon is moved to the second access area if a menu icon lower than the first higher menu icon is generated, and the lower menu icon is arranged in the first access area.

48. The method as claimed in claim 9, wherein the step c) comprises:
c1) determining whether the circumference of a menu arrangement area where the menu icons are arranged is included in a part below an upper corner of the touch screen;
c2) determining a start point and an end point of menu icon arrangement in accordance with the determined result;
c3) determining an arrangement direction of the menu icons from the start point to the end point; and
c4) arranging the menu icons in accordance with the determined arrangement direction.

49. The method as claimed in claim 48, wherein the step c1) comprises setting S1 if the circumference of the menu arrangement area is not included in the part below the upper corner of the touch screen and setting S2 if the circumference of the menu arrangement area is included in the part below the upper corner of the touch screen.

50. The method as claimed in claim 49, wherein the step c2) comprises in the case of S1:
setting an intersection point between the upper corner of the touch screen and the circumference as a start point and an apex in a diagonal direction of the start point as an end point if an intersection point between the circumference and both corners of the touch screen does not occur; and
setting the intersection point between the upper corner of the touch screen and the circumference as a start point and an intersection point occurring in the nearest corner as an end point if the intersection point between the circumference and the nearest corner of both corners of the touch screen occurs.

51. The method as claimed in claim 49, wherein the step c2) comprises in the case of S2:
setting an intersection point between the circumference and the nearest corner as a start point and an end point if the intersection point between the circumference and the nearest corner occurs;
setting an intersection point between the circumference and the nearest corner as a start point and an intersection point between the circumference and a lower corner as an end start point if the intersection point between the circumference and the lower corner as well as the nearest corner occurs; and
setting an apex between the nearest corner of both corners of the touch screen and the upper corner as a start point and an apex between the nearest corner and the lower corner as an end point if no intersection point between the circumference and the corners of the touch screen occurs.

52. The method as claimed in claim 48, wherein the arrangement direction in the step c3) is counterclockwise in the case of L1 and clockwise in the case of L2.

53. The method as claimed in claim 48, wherein the step c4) comprises arranging the menu icons considering the attention area along with first to n-th access areas divided depending on the user's access easiness.

54. The method as claimed in claim 53, wherein the first access area is provided with a first higher menu icon, the first higher menu icon is moved to the second access area if a menu icon lower than the first higher menu icon is generated, and the lower menu icon is arranged in the first access area.

55. The display device as claimed in claim 25, wherein the menu control unit comprises:
a determining unit for determining whether the circumference of a menu arrangement area where the menu icons are arranged is included in a part below an upper corner of the touch screen;
a start/end point determining unit for determining a start point and an end point of menu icon arrangement in accordance with the determined result of the determining unit;
a menu arrangement determining unit for determining an arrangement direction of the menu icons from the start point to the end point determined by the start/end point determining unit; and
a menu arrangement unit arranging the menu icons in accordance with the arrangement direction determined by the menu arrangement determining unit.

56. The display device as claimed in claim 55, wherein the determining unit sets S1 if the circumference of the menu arrangement area is not included in the part below the upper corner of the touch screen, and sets S2 if the circumference of the menu arrangement area is included in the part below the upper corner of the touch screen.

57. The display device as claimed in claim 56, wherein the start/end point determining unit, in the case of S1, sets an intersection point between the upper corner of the touch screen and the circumference as a start point and an apex in a diagonal direction of the start point as an end point if an intersection point between the circumference and both corners of the touch screen does not occur, and sets an intersection point between the upper corner of the touch screen and the circumference as a start point and an intersection point occurring in the nearest corner as an end point if the intersection point between the circumference and the nearest corner of both corners of the touch screen occurs.

58. The display device as claimed in claim 56, wherein the start/end point determining unit, in the case of S2, sets an intersection point between the circumference and the nearest corner as a start point and an end point if the intersection point between the circumference and the nearest corner occurs, sets an intersection point between the circumference and the nearest corner as a start point and an intersection point between the circumference and a lower corner as an end start point if the intersection point between the circumference and the lower corner as well as the nearest corner occurs, and sets an apex between the nearest corner of both corners of the touch screen and the upper corner as a start point and an apex between the nearest corner and the lower corner as an end point if no intersection point between the circumference and the corners of the touch screen occurs.

59. The display device as claimed in claim 55, wherein the arrangement direction of the menu arrangement determining unit is counterclockwise in the case of L1, and clockwise in the case of L2.

60. The display device as claimed in claim 55, wherein the menu arrangement unit arranges the menu icons considering the attention area along with first to n-th access areas divided depending on the user's access easiness.

61. The display device as claimed in claim 60, wherein the menu arrangement unit includes a first higher menu icon arranged in the first access area, the first higher menu icon being moved to the second access area if a menu icon lower than the first higher menu icon is generated, and the lower menu icon being arranged in the first access area.

62. The display device as claimed in claim 26, wherein the menu control unit comprises:
a determining unit for determining whether the circumference of a menu arrangement area where the menu icons are arranged is included in a part below an upper corner of the touch screen;
a start/end point determining unit for determining a start point and an end point of menu icon arrangement in accordance with the determined result of the determining unit;
a menu arrangement determining unit for determining an arrangement direction of the menu icons from the start point to the end point determined by the start/end point determining unit; and
a menu arrangement unit arranging the menu icons in accordance with the arrangement direction determined by the menu arrangement determining unit.

63. The display device as claimed in claim 62, wherein the determining unit sets S1 if the circumference of the menu arrangement area is not included in the part below the upper corner of the touch screen, and sets S2 if the circumference of the menu arrangement area is included in the part below the upper corner of the touch screen.

64. The display device as claimed in claim 63, wherein the start/end point determining unit, in the case of S1, sets an intersection point between the upper corner of the touch screen and the circumference as a start point and an apex in a diagonal direction of the start point as an end point if an intersection point between the circumference and both corners of the touch screen does not occur, and sets an intersection point between the upper corner of the touch screen and the circumference as a start point and an intersection point occurring in the nearest corner as an end point if the intersection point between the circumference and the nearest corner of both corners of the touch screen occurs.

65. The display device as claimed in claim 63, wherein the start/end point determining unit, in the case of S2, sets an intersection point between the circumference and the nearest corner as a start point and an end point if the intersection point between the circumference and the nearest corner occurs, sets an intersection point between the circumference and the nearest corner as a start point and an intersection point between the circumference and a lower corner as an end start point if the intersection point between the circumference and the lower corner as well as the nearest corner occurs, and sets an apex between the nearest corner of both corners of the touch screen and the upper corner as a start point and an apex between the nearest corner and the lower corner as an end point if no intersection point between the circumference and the corners of the touch screen occurs.

66. The display device as claimed in claim 62, wherein the arrangement direction of the menu arrangement determining unit is counterclockwise in the case of L1, and clockwise in the case of L2.

67. The display device as claimed in claim 62, wherein the menu arrangement unit arranges the menu icons considering the attention area along with first to n-th access areas divided depending on the user's access easiness.

68. The display device as claimed in claim 67, wherein the menu arrangement unit includes a first higher menu icon arranged in the first access area, the first higher menu icon being moved to the second access area if a menu icon lower than the first higher menu icon is generated, and the lower menu icon being arranged in the first access area.
